(19) United States
(12) Patent Application Publication
(10) Pub. No.: US 2005/0268557 A1
(43) Pub. Date: Dec. 8, 2005

(54) Revolving door

(75) Inventor: Niels Jacob Huber, Edam (NL)

Correspondence Address: PEACOCK MYERS, P.C., P O BOX 26927, ALBUQUERQUE, NM, 87125-6927, US

(73) Assignee: BOON EDAM B.V., Edam (NL)

(21) Appl. No.: 11/148,391

(22) Filed: Jun. 7, 2005

(30) Foreign Application Priority Data
Jun. 7, 2004 (NL) 1026344

(51) Int. Cl. E05D 15/02

(52) U.S. Cl. 49/42

(57) ABSTRACT

A revolving door comprising a cylindrical wall, and placed above the cylindrical wall a roof construction provided with a connecting element disposed in the centre of the door and girders extending radially therefrom, with at least one rotatable door leaf being suspended from the roof construction within the cylindrical wall and below the roof construction, while the cylindrical wall is provided with passage openings, the girders being placed under pre-tension, in order to create an upward force on the connecting element.

The invention relates to a revolving door comprising a cylindrical wall, and placed above the cylindrical wall a roof construction, with at least one rotatable door leaf being disposed within the cylindrical wall and below the roof construction, wherein the cylindrical wall is provided with passage openings.

Applicant has had such a revolving door on the market for many years now, and it is also known, for example, from the British patent application GB-A-2 052 612. From this publication it is also known to embody the revolving door such that the roof construction is provided with a connecting element disposed in the centre of the door and girders extending radially therefrom.

From GB-A-2 131 073, a revolving door is known comprising a cylindrical wall and a roof construction disposed above the cylindrical wall, having a connecting element placed in the centre of the door and girders extending radially therefrom, with at least one rotatable door leaf being suspended from the roof construction within the cylindrical wall and below the roof construction, while the cylindrical wall is provided with passage openings.

The known revolving door has the drawback that it is endowed with little flexibility. This may be illustrated as follows. The life span of a revolving is approximately twelve years, while the building in which the same is employed will often not stand more than 30 years. On average, the function of the building changes once every four years. This means that within the life span of the known revolving door, the demands with respect to the revolving door's functionality may change three times. For example, when a supermarket is housed in the building, a three-leafed revolving door is needed in order to allow the pulsed passage of customers with shopping trolleys. A builder's merchant, on the other hand, would rather use a two-leafed revolving door in combination with sliding doors. The underlying reason being the large segments that this door has and that render this door suitable for the trolleys carrying gypsum plates as sold at a builder's merchant. In such a case it is also desirable for the revolving door to be embodied without a central column.

Apart from the objective of flexibility as explained in the foregoing, the present invention is also aimed at the realisation of a fast starting time and stopping time of the revolving door, in connection with the safety requirements concerning the person passing through the revolving door.

These and other objectives that will become apparent from the following are realised with a revolving door that is characterized by one or several of the appended claims.

In a first aspect of the invention, the revolving door is characterized in that the girders are placed under pre-tension, in order to create an upward force on the connecting element. This achieves among other things, that the roof construction, even in the case of the revolving door having a large diameter, is able to meet the practical requirements with respect to the allowable roof load, which is approximately 1000 N/m². The door leaf or door leaves may then be as light as possible in order for the revolving door to be able to realise a fast starting and stopping time.

In another aspect, the revolving door according to the invention is characterized in that the roof construction comprises a rail and that the at least one door leaf has at the topside at least one roller that is accommodated in the rail, and by which the door leaf is suspended from the roof construction. In this manner, the suspension of the at least one door leaf can at the same time serve for its propulsion, in particular in the embodiment that is characterized in that the at least one roller is provided with a motor drive.

In a preferred embodiment, the revolving door is characterized in that the same possesses posts on which the roof construction is placed. This affords the designer of the revolving door a vast degree of freedom, while the door can be completed independently of the architect who has designed the building in which the revolving door is going to be used. The positioning of the posts is also flexible; only the area of the passage openings must remain free of posts.

A first preferred embodiment to realise one thing and another, is characterized in that the posts are positioned at the cylindrical wall and support ends of cross girders, and that the radially extending girders of the roof construction rest on said cross girders, with the rail being suspended via tension rods from ends of these girders located near the cylindrical wall.

A second preferred embodiment to realise this is characterized in that the rail of the roof construction rests on the posts, and that ends of the radially extending girders of the roof construction at the cylindrical wall side also rest on these posts, with the girders being provided with tension rods to allow a tensile load to be exerted on the underside of the girders.

Furthermore, the revolving door may be embodied such that the at least one door leaf is removable and replaceable. This fulfils the practical need of a great degree of flexibility, as explained in the foregoing. When replacing the door wings it is, for example, possible to change to a number of door leaves that differs from the original number, e.g. two, three, four or even more than four door leaves, all in accordance with the requirements at that moment. It is further in general possible to largely standardise the production of various types of revolving doors. This will be explained below.

In the case of the revolving door according to the invention having very large diameters, it may be desirable to embody the door such that the roof construction is founded in the structure of a building.

Hereinbelow the invention will be further elucidated by way of some exemplary embodiments that do not limit the claims, and with reference to the drawing. The drawing shows in:

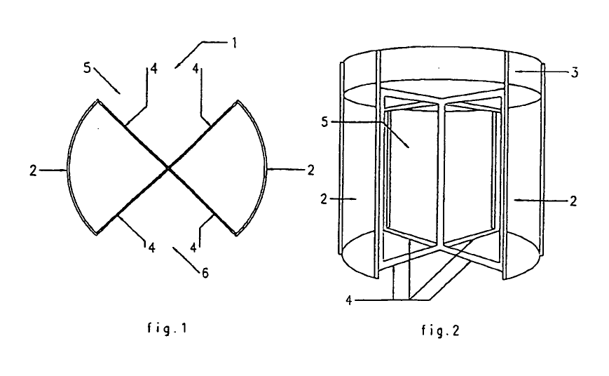

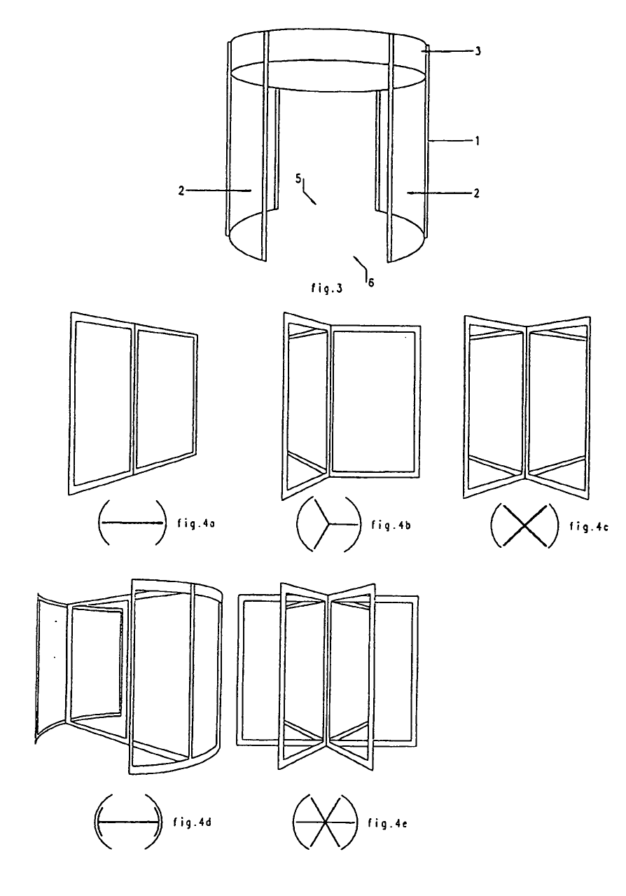

FIG. 1, a cross section of the revolving door according to the invention shown in FIG. 2;

FIG. 2, a three dimensional view of the revolving door according to the invention;

FIG. 3, a cylindrical wall and roof construction of the revolving door according to the invention;

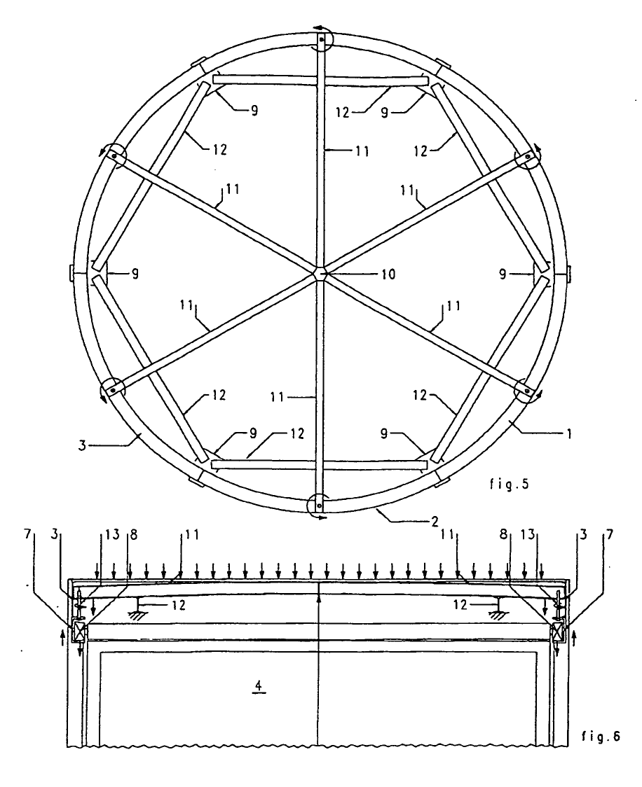

FIGS. 4a to 4e, several types of door leaves that can be used in combination with the cylindrical wall and roof construction of the revolving door according to the invention shown in FIG. 3;

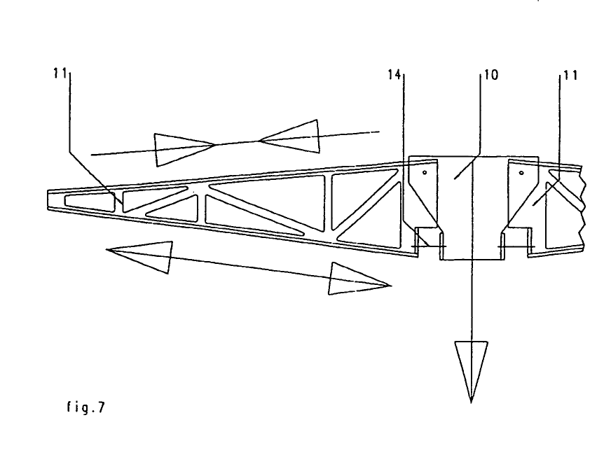

FIGS. 5 and 6, a top view and mid-sectional view of a first embodiment of the revolving door according to the invention;

FIG. 7, a second embodiment of a portion of the roof construction of the revolving door according to the invention; and

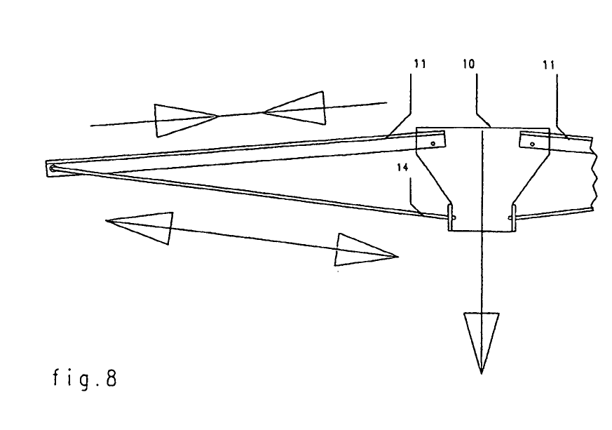

FIG. 8, a third embodiment of a portion of the roof construction of the revolving door according to the invention.

Identical reference numerals used in the figures refer to similar components.

With reference first to FIG. 1 and FIG. 2, a revolving door 1 is shown possessing a cylindrical wall 2 and a roof construction 3 (see FIG. 2) placed above the cylindrical wall 2.

Within the cylindrical wall 2 and underneath the roof construction 3, the case illustrated in FIGS. 1 and 2 shows 4 rotatably disposed door leaves 4. The cylindrical wall 2 of the revolving door 1 also comprises passage openings 5 and 6 allowing users to pass through the revolving door 1.

With the exception of the door leaves 4, FIG. 3 shows the same components that have just been elucidated by way of FIG. 2.

In accordance with the invention, the revolving door 1 as shown in FIG. 3 is used in combination with at least one door leaf as shown in FIG. 4a, which is suspended from the roof construction 3.

The special feature of the revolving door 1 according to the invention is, that it allows the revolving door 1 to be adapted in a flexible manner to the requirements of use. FIGS. 4b and 4c show a three-leafed and four-leafed element, respectively, that within the cylindrical wall 2 can be suspended from the roof construction 3 to comply with the practical need and the circumstances in which the revolving door 1 will have to be employed.

FIG. 4d and FIG. 4e show some possible further variations that together with the construction shown in FIG. 3 may provide a revolving door according to and within the scope of the invention. It will be apparent, that the cylindrical wall 2 and the roof construction 3 together form a module, which allows a largely standardised production of the desired embodiment of the revolving door 1 according to the invention. In addition, one man is well able to install the door.

In order to further elucidate the removable suspension of the at least one door leaf, reference is now made to FIG. 5 and FIG. 6.

FIG. 6 shows that the roof construction 3 possesses a rail 7 and that the at least one door leaf 4 has at the top side at least one, and in the case shown, two rollers 8 that are accommodated in the rail 7, and by which the door leaf 4 is suspended from the roof construction 3.

Preferably at least one roller 8 is provided with a motor drive. If one single door leaf is employed, it is for consideration of symmetry desirable to use two rollers 8, and both to be provided with a motor drive. The person skilled in the art is quite familiar with the manner in which one thing and another needs to be carried out, so that a further explanation is not necessary.

Desirably, the roof construction 3 is founded in, for example, the construction of the building in which the revolving door is employed.

FIGS. 5 and 6 show a different way for the roof construction 3 to be self-supporting, namely an embodiment in which posts 9 (see FIG. 5) are used upon which the roof construction 3 is placed.

Herein the roof construction 3 possesses a connecting element 10 placed in the centre of the revolving door, to which girders 11 radially extending therefrom are coupled. These girders 11 are placed under pre-tension in order to realise an upward force on the connecting element 10.

To this end, the ends of cross girders 12 rest on posts 9 positioned at the cylindrical wall 2, such that these cross girders 12, as it were, form chords within a circumferential circle formed by the cylindrical wall 2. On these cross girders 12 rest the radially extending girders 11 of the roof construction 3 (see FIG. 5), while, and this is clearly shown in FIG. 6, via tension rods 13 the rail 7 of the roof construction 3 is suspended from these girders 11 located at the cylindrical wall 2. A possible second and third embodiment for realising that the connecting element 10 of the roof construction 3 undergoes an upward force is schematically illustrated in the FIGS. 7 and 8.

In the construction shown in the FIGS. 7 and 8, the rail of the roof construction rests directly on the posts. The FIGS. 7 and 8 do not show this. Therefore one thing and another deviates from the embodiment as shown and explained with reference to the FIGS. 5 and 6. Another difference is that the ends of the radially extending girders of the roof construction located near the cylindrical wall also rest on these posts. The person skilled in the art will be quite familiar with the way in which one thing and another needs to be carried out so that, for the sake of clarity, these constructional aspects are not shown in the FIGS. 7 and 8.

FIG. 7 shows the second embodiment of the girders 11 for placing these under pre-tension, in order to realise an upward force on the connecting element 10. FIG. 7 shows that to this end, the girders 11 may at their underside be provided with a tension rod 14, to allow these girders 11 at their underside to be pulled in the direction of the connecting element 10.

FIG. 8 shows a third embodiment wherein a tension rod 14 is used, which extends between the connecting element 10 and the end of the girder 11 that faces away from the connecting element 10. This latter end, as mentioned above, as well as the corresponding end of girder 11 shown in FIG. 7, also rests on a post on which also the roof construction and in particular its rail rest.

It should be understood that the foregoing description forms no limitation to the appended claims. The description and elucidation referring to a number of examples merely serve to explain these claims without limiting the protective scope due these claims to the exemplary embodiments given.

1. A revolving door comprising a cylindrical wall, and placed above the cylindrical wall a roof construction having a connecting element placed in the center of the door and girders extending radially therefrom, with at least one rotatable door leaf being suspended from the roof construction within the cylindrical wall and below the roof construction, while the cylindrical wall is provided with passage openings wherein the girders are placed under pre-tension to create an upward force on the connecting element.

2. A revolving door according to claim 1, wherein the roof construction comprises a rail and the at least one door leaf has at the topside at least one roller that is accommodated in the rail, and by which the door leaf is suspended from the roof construction.

3. A revolving door according to claim 2, wherein the at least one roller is provided with a motor drive.

4. A revolving door according to claim 1, additionally comprising posts on which the roof construction is placed.

5. A revolving door according to claim 4, wherein the positioning of the posts outside of the area of passage openings is flexible.

6. A revolving door according to claim 4, wherein that the posts are positioned at the cylindrical wall and support ends of cross girders, and the radially extending girders of the roof construction rest on said cross girders, with the rail being suspended via tension rods from ends of these girders located near the cylindrical wall.

7. A revolving door according to claim 6, wherein a rail of the roof construction rests on the posts, and ends of the radially extending girders of the roof construction at the cylindrical wall side rest on these posts, with the girders being provided with tension rods to allow a tensile load to be exerted on the underside of the girders.

8. A revolving door according to claim 1, wherein the at least one door leaf is removable and replaceable.

9. A revolving door according to claim 1, wherein the roof construction is founded in the structure of a building.
